(19) United States
(12) Patent Application Publication
(10) Pub. No.: US 2010/0239741 A1
(43) Pub. Date: Sep. 23, 2010

(54) AFTER MARKET WINE ADDITIVE TO BALANCE THE FLAVOR OF A WINE

(76) Inventor: Mark Takita, Palo Alto, CA (US)

Correspondence Address: Roeder & Broder LLP, 5560 Chelsea Avenue, La Jolla, CA, 92037, US

(21) Appl. No.: 12/728,973

(22) Filed: Mar. 22, 2010

Related U.S. Application Data
(60) Provisional application No. 61/162,583, filed on Mar. 23, 2009.

(51) Int. Cl. C12G 3/06

(52) U.S. Cl. 426/592

(57) ABSTRACT

A method for adjusting the flavor of a wine after the wine is opened includes the step of selectively adding a first wine additive to the wine, the first wine additive being made at least partly from concentrated grape juice that approximately match a first grape variety of the wine. For example, the first wine additive can be made at least partly from the first grape variety. Because the first wine additive is made from concentrated grape juice that approximately match the first grape variety, the first wine additive adds sugar to the wine, after a bottle has been opened for consumption by the consumer. Adding concentrated grapes derived from the varietals in the wine to be improved, further enhances the wine, while preserving the character of the original wine.

### PRIOR APPLICATION

This application claims priority on U.S. Provisional Application Ser. No. 61/162,583, filed Mar. 23, 2009 and entitled “WINE ADDITIVE.” As far as permitted, the contents of U.S. Provisional Application Ser. No. 61/162,583 are incorporated herein by reference.

### BACKGROUND

During the production, and fermentation of wine, sugars are converted to alcohol. During the processing of wine the conversion process can excessively deplete the sugar content. In addition, the acidity of the wine can become high, especially relative to the sugar content. It is well known, that prior to bottling of the wine, the flavor of acidity is balanced by adjusting the sugar content of the wine. An example of this would be dessert wines. These beverages typically have very high acidity. In a well balanced beverage of this sort, that acid flavor is balanced by a high sugar content, which gives the beverage a perceived balance between the sugars and acids, which make the beverage more palatable to the consumer.

Because of oxidative processes which are controlled by a multivariable environment, (time, temperature, chemical composition, etc.), the acid and sugar characteristics of the wine, after it has been bottled, and opened by the consumer, can be difficult to control and predict, prior to packaging and bottling. In addition, producers can not control or accurately predict when the wine will be consumed.

Typically, after the wine has been bottled or packaged for distribution, wine is not currently adjusted, mainly because of the complexity, and cost of doing so. Adjusting the wine after it has been packaged (e.g. bottled), requires an extensive reprocessing of the beverage. In addition, this kind of processing introduces additional variables by potentially exposing the wine to air during reprocessing. This exposure to air, can prematurely accelerate oxidation and chemical changes in the wine.

### SUMMARY

The present invention is directed to a method for adjusting the flavor of a wine after the wine is opened. The wine is made at least partly from a first grape variety. In one embodiment, the method includes the step of selectively adding a first wine additive to the wine, the first wine additive being made at least partly from concentrated grape juice that approximately matches the first grape variety and/or that complement the first grape variety. As used herein, the term approximately matches can mean the varietals used in the additive have characteristic flavors that are similar to the primary varietal(s) used in the wine, though may not contain the same percentages by volume of the different varietal combinations. In certain embodiments, the first wine additive is made at least partly from the first grape variety.

As provided herein, bottled wine can often have too acidic a flavor, which gives the drinker a perception of drinking a bitter and unbalanced wine. Further, as provided herein, the addition of sugars tends to balance the acid content of the wine and the balancing of the wine's flavor, is considerably improved, by adding sweetness which is derived from wine grapes. With the present invention, because the first wine additive is made from concentrated grapes that approximately match the first grape variety, the first wine additive adds sugar to the wine, after a bottle has been opened for consumption by the consumer. Importantly, adding concentrated grapes derived from the varietals in the wine to be improved, further enhances the wine, while preserving the character of the original wine. For example, one could add concentrated, unfermented cabernet sauvignon juice, to a bottle of cabernet sauvignon wine which is perceived as too acid in flavor by the wine's consumer. In contrast, for example, if common table sugar was added to the wine, the common sugar could add components of flavor associated with the type of sugar being added. As a result thereof, the resulting adjusted wine could have a flavor that is quite different from that of the original wine, and that which is intended.

Further, as provided herein, the adjustment of the wine is best done just prior to consumption (e.g. after market), when the wine can be best characterized both before adjustment and after adjustment. For that case, the after adjustment perceived flavor will change sufficiently slowly enough so the adjustment can be clearly appreciated by the beverage consumer. In addition, that adjustment can be specifically tailored by that consumer, to best match their own preferences. It remains clear that such adjustment can be done at any point after the end of wine production. However, the longer the time period between adjustment and consumption, the greater the chemical activity and changes in the beverage, and the greater the change in the final flavor of the wine. Sugar content and acid content remain a dynamic balance over time, influenced by many variables.

The amount of concentrated grape juice to be added could be decided based on the preference of the drinker. Small amounts could be added until the flavor of the wine is to the liking of the consumer. Another method would be to recommend, through use of tables, a particular amount, based on the perceived bitterness, and quantity of the wine. Further, if acid and sugar content of the wine are described, as often the case, a recommended amount could be described to the consumer, using tables, or a simple calculation. These calculations could also be presented to the consumer in the form of software, or an application which could be run on and personal electronic device.

In another embodiment, the consumer could be provided tools to measure the acid content and sugar content of a wine. For example, litmus paper, and a refractometer are common ways of measuring these quantities. Based on these measurements, a table, or quick calculation could be made, and a recommended amount of the additive could be suggested.

The concentrated additives used have a sweetness and flavor derived from the varietal used. As such, in an advanced application, the additive could not only be used to balance the acid content, but, could be also used to add more complexity to the wine. For example, if a cabernet concentrated sweetener were added to a merlot wine, this would add the additional flavors of the cabernet grape, to the merlot. This could add more complexity to the merlot, and yield a more favorable flavor to the consumer, prior to consumption.

Additionally, the wine can be a blended wine that is also made at least partly from a second grape variety. In this embodiment, the first wine additive can also being made at least partly from concentrated grapes that approximately match the second grape variety. Still further, the blended wine can also be made at least partly from a third grape variety. In this embodiment, the first wine additive also being made at least partly from concentrated grapes that approximately match the third grape variety.

The present invention is also directed to another method for adjusting the flavor of a wine after the wine is opened. In this embodiment, the method includes the steps of: (i) providing a wine additive combination that includes a first wine additive, and a second wine additive, the first wine additive being made at least partly from concentrated grapes having a first composition, the second wine additive being made at least partly from concentrated grapes having a second composition that is different from the first composition; (ii) selecting one of the wine additives based on which wine additive is made at least partly from grapes that approximately match the first grape variety; and (iii) selectively adding the selected wine additive.

Additionally, as provided herein, the wine can be tested with a test kit to determine the amount of the selected wine additive that should be added to the wine.

Further, the present invention is directed to a wine additive combination for adjusting the flavor of a first wine and a second wine after the wines have been opened, the first wine being made at least partly from a first grape variety, the second wine being made at least partly from a second grape variety that is different from the first wine variety. In this embodiment, the combination includes (i) a first wine additive that is made at least partly from concentrated grapes having a first composition that approximately matches the first grape variety; and (ii) a second wine additive that is made at least partly from concentrated grapes having a second composition that approximately matches the second grape variety, the second composition being different from the first composition. In certain embodiments, the first wine additive is made at least partly from the first grape variety, and the second wine additive is made at least partly from the second grape variety.

As provided herein, at least one of the additives can be made from freeze dried, or dehydrated grape juice. Alternatively, or additionally, at least one of the additives can be made from non-fermented non-concentrated grape juice or concentrated grape juice.

### DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified illustration of a wine additive assembly having features of the present invention, and a plurality of wines.

### DESCRIPTION

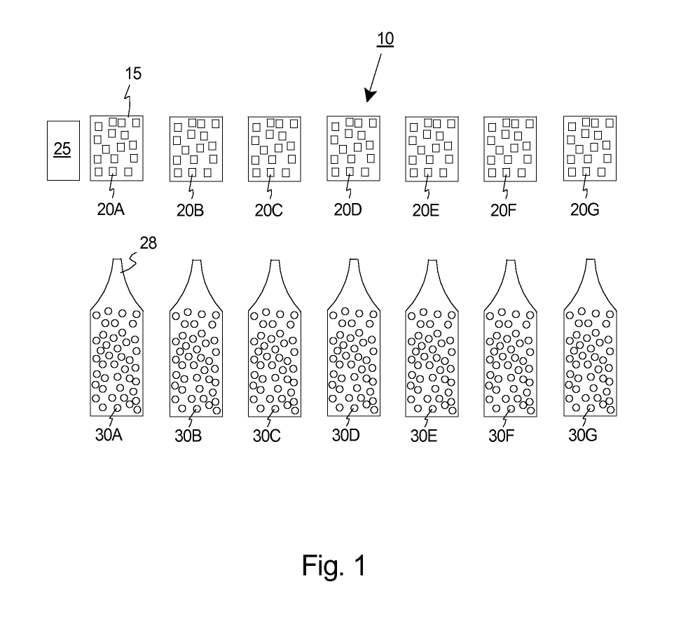

FIG. 1 is a simplified illustration of a wine additive combination 10 having features of the present invention that includes a plurality of additive containers 15 that each contains a different wine additive 20A-20G (illustrated as small squares), and a wine test assembly 25. FIG. 1 also illustrates a plurality of bottles 28, and each of the bottles 28 contains a different type of wine 30A-30G (illustrated as circles). As an overview, in certain embodiments, one or more of the wine additives 20A-2G can be selectively added to one or more of the wines 30A-30G to alter, adjust and/or enhance the taste of one or more of the wines 30A-30G after the wines 30A-30G have been opened by the consumer. With this design, the wine additive combination 10 can be sold to a consumer so that the consumer can adjust their own wines 30A-30G after they have been opened.

It should be noted that any of the different wines 30A-30G can be referred to as a first, second, third, fourth, etc. wine for convenience. The types of the wines 30A-30G adjusted with the present invention is limitless. As non-exclusive examples, one or more of the wines 30A-30B can be varietal types (e.g. using single grape variety) such as (i) red grapes: Alicante Bouschet, Barbarossa, Barbera, Black Muscat, Cabernet Franc, Cabernet, Concord, Sauvignon, Carignan, Carménère, Cinsaut, Castiglione, Chambourcin, Dolcetto, Petite Sirah, Gamay, Grenache, Graciano, Lagrein, Lambrusco, Malbec, Merlot, Montepulciano, Nebbiolo, Petit Verdot, Pinot Noir, Sangiovese, Syrah, Zinfandel; and (ii) white grapes: Aligoté, Chardonnay, Chasan, Chenin Blanc, Clairette, Colombard, Gewürztraminer, Muscadelle, Muscat, Pinot Blanc, Pinot Grigio, Prosecco, Riesling, Roussanne, Sauvignon Blanc, Sémillon, Trebbiano, Viognier. An additional discussion of different types of grapes is included in Oz Clarke's Grapes and Wines: The definitive guide to the world's great grapes and the wines they make, by Oz Clarke(Author), Margaret Rand (Author), Publisher: Harvest Books (May 7, 2007), the contents of which are incorporated herein by reference.

In these examples, (i) the first wine 30A can be said to be made of a first grape variety and have a first composition, (ii) the second wine 30B can be said to be made of a second grape variety (that is different from the first grape variety) and have a second composition (that is different from the first composition); (iii) the third wine 30C can be said to be made of a third grape variety (that is different from the first and grape varieties) and have a third composition (that is different from the first and second compositions); and (iv) the same type of description for the rest of the wines 30D-30G.

Alternatively, as non-exclusive examples, one or more of the wines 30A-30B can be blended types (e.g. using two or more grape varieties that are blended) such as Chardonnay-Viognier, Cabernet Sauvignon-Merlot, Cabernet Sauvignon-Syrah, Grenache-Mourvedre-Syrah, AOC (Appellation d'origine contrôlée) wines such as: (Bordeaux which is primarily from: Cabernet Sauvignon, Merlot, Cabernet Franc, Petit Verdot, Malbec and Carmenere.),Cotes du Rhone, Burgundy, Gigondas, etc.). For example, (i) the first wine 30A can be said to be made by the blending of a first grape variety, a second grape variety, etc (depending on the number of grape varieties blended into the first wine), and (ii) the same type of description for the rest of the wines 30B-30G.

The number and design of wine additives 20A-20G used in the wine additive combination 10 can be varied to suit the needs of the consumer. For example, in FIG. 1, the wine additive combination 10 includes seven different wine additives 20A-20G. Alternatively, the wine additive combination 10 can include more than seven or less than seven different wine additives 20A-20G. Still alternatively, the wine additive combination 10 can multiple of the same wine additives 20A-20G.

As provided herein, one or more of the wine additives 20A-20G is made of concentrated grape juice that is provided to the consumer in liquid form, or a dried form (such as freeze-dried, or simply dried). In certain embodiments, the concentrated grape juice is not fermented and is non-alcoholic .

Packets (e.g. the container 15) containing the concentrated dried wine additive 20A-20G, could take the form somewhat similar to that of commonly used sugar packets, and be labeled with the varietal. The packet sizes could be customized to the amounts typically used. For example, glass size, half bottle size (350 ml), 750 ml bottle size, magnum, jerobaum, etc. Alternatively, the container 15 can be a bottle that contains the liquid form of the wine additive 20A-20G. In this design, the bottle can also be sized to the amounts typically used.

It should be noted that any of the different wine additives 20A-20G can be referred to as a first, second, third, fourth, etc. wine additive for convenience. In certain embodiments, the types of concentrated grapes used for the wine additives 20A-20G is almost limitless.

As non-exclusive examples, one or more of the wine additives 20A-20B can be varietal types (e.g. using single grape variety) (referred to herein as a “varietal wine additive”) such as (i) red grapes: Alicante Bouschet, Barbarossa, Barbera, Black Muscat, Cabernet Franc, Cabernet, Concord, Sauvignon, Carignan, Carménère, Cinsaut, Castiglione, Chambourcin, Dolcetto, Petite Sirah, Gamay, Grenache, Graciano, Lagrein, Lambrusco, Malbec, Merlot, Montepulciano, Nebbiolo, Petit Verdot, Pinot Noir, Sangiovese, Syrah, Zinfandel; and (ii) white grapes: Aligoté, Chardonnay, Chasan, Chenin Blanc, Clairette, Colombard, Gewürztraminer, Muscadelle, Muscat, Pinot Blanc, Pinot Grigio, Prosecco, Riesling, Roussanne, Sauvignon Blanc, Sémilln, Trebbiano, Viognier.

In these examples, (i) the first varietal wine additive 20A can be said to be made of a first grape variety and have a first composition, (ii) the second varietal wine additive 20B can be said to be made of a second grape variety (that is different from the first grape variety) and have a second composition (that is different from the first composition); (iii) the third varietal wine additive 20C can be said to be made of a third grape variety (that is different from the first and grape varieties) and have a third composition (that is different from the first and second compositions); and (iv) the same description for the rest of the wine additives 20D-20G.

Alternatively, as non-exclusive examples, one or more of the wine additives 20A-20B can be blended types (e.g. using two or more grape varieties that are blended) (referred to herein as a “blended wine additive”) such as Chardonnay-Viognier, Cabernet Sauvignon-Merlot, Cabernet Sauvignon-Syrah, Grenache-Mourvedre-Syrah, AOC (Appellation d'origine contrôlée) wines such as: (Bordeaux which is primarily from: Cabernet Sauvignon, Merlot, Cabernet Franc, Petit Verdot, Malbec and Carmenere.),Cotes du Rhone, Burgundy, Gigondas, etc.). For example, (i) the first blended wine additive 20A can be said to be made by the blending of a first grape variety, a second grape variety, etc (depending on the number of grape varieties blended into the first wine additive), and (ii) the same type of description for the rest of the wine additives 20B-20G.

In use, after opening the bottle 28 containing a wine 30A-30G, the consumer can select and add one or more of the wine additives 20A-20G to adjust the flavor of the wine 30A-30G. For example, the wine additive 20A-20G can be selected to approximately match, exactly match, or complement the variety of the wine 30A-30G. For example, for a single grape variety wine 30A-30G, the wine additive 20A-20G can be selected that approximately matches the single grape variety of the wine, exactly matches the grape variety of the wine, or complements the grape variety of the wine.

As non-exclusive examples, (i) a wine additive made of concentrated cabernet juice could be used for a cabernet sauvignon wine, (ii) a wine additive made of concentrated Chardonnay juice could be used be for a Chardonnay wine, (iii) a wine additive made of concentrated Merlot juice could be used be for a Merlot wine, (iv) a wine additive made of concentrated cabernet sauvignon juice could be used be for a Merlot wine, (v) a wine additive made of concentrated Vigionier juice could be used be for a Chardonnay wine.

Alternatively, for a blended wine 30A-30G made of two or more grape varieties, one or more the varietal wine additives 20A-20G can be selected that approximately matches one of grape varieties of the wine, exactly matches one of the grape varieties of the wine, or complements the grape varieties of the wine. Alternatively, one or more blended wine additives 20A-20G can be selected that approximately matches, exactly matches, or complements the blended wine 30A-30G.

As non-exclusive examples, (i) a wine additive made of concentrated Cabernet Sauvignon juice and Merlot juice could be used for a Cabernet Sauvignon wine, (ii) a wine additive made of concentrated Chardonnay juice and a wine additive made of concentrated Viognier juice could be used be for a Chardonay wine, (iii) a wine additive made of concentrated Grenache juice and Merlot juice could be used for a Cabernet Sauvignon wine, (iv) a wine additive made of concentrated Syrah juice and Grenache juice could be used for a Cabernet Sauvignon wine.

In a more elaborate form, the additive 20A-20G could mimic the type of blended wine too which it is being added. This could be done it many ways. In one implementation, the consumer could pre-blend the additive. In another implementation, premixing of the additive could be done and offered to the consumer. For example, GSM wines coming from Australia, and appellation wine coming form Gigondas, France, commonly contain Grenache, Syrah, and Mourvedre varietals. An additive 20A-20G which is made up of these varietal of concentrated grape juices, could be used as an additive for such wines. The blending of the additive 20A-20G could mimic the approximate average content of the typical GSM wine. Further more, the blend does not have to have an exact ratio matching the wine. An approximate ratio would suffice. This could apply to such types as Bordeaux red wine, Gigondas, and many other types. European wine is typically made from specific blends of varietals, as directed by the AOC (Appellation d'origine contrôlée) controlling agency, and indicated by the region in which they were produced.

In certain embodiments, the consumer is provided with a wine test assembly 25 that can be used to measure the acid content and sugar content of the wine 30A-30G. For example, the test assembly 25 can include litmus paper, and a refractometer. Further, based on measurements with the test assembly 25, a table (provided with the test assembly), or quick calculation could be made, and a recommended type or amount of the additive 20A-20G could be suggested.

While the current invention is disclosed in detail herein, it is to be understood that it is merely illustrative of the presently preferred embodiments of the invention and that no limitations are intended to the details of construction or design herein shown other than as described in the appended claims.

What is claimed is:

1. A method for adjusting the flavor of a wine after the wine is opened, the wine being made at least partly from a first grape variety, the method comprising the step of:
selectively adding a first wine additive to the wine, the first wine additive being made at least partly from concentrated grape juice.

2. The method of claim 1 wherein the step of selectively adding includes the first wine additive being made at least partly from the first grape variety.

3. The method of claim 1 wherein the wine is also made at least partly from a second grape variety, and wherein the step of selectively adding includes the first wine additive being made at least partly from concentrated grape juice that approximately matches the first grape variety and the second grape variety.

4. The method of claim 3 wherein the wine is also made at least partly from a third grape variety, and wherein the step of selectively adding includes the first wine additive also being made at least partly from concentrated grape juice that approximately match the third grape variety.

5. The method of claim 1 wherein the wine is also made at least partly from a second grape variety, and wherein the step of selectively adding includes the first wine additive being made at least partly from the first grape variety and at least partly from the second grape variety.

6. The method of claim 5 wherein the wine is also made at least partly from a third grape variety, and wherein the step of selectively adding includes the first wine additive being made at least partly from the third grape variety.

7. The method of claim 1 further comprising the step of providing a wine additive combination that includes the first wine additive, and a second wine additive, the second wine additive being made at least partly from concentrated grapes that are different from the first grape variety.

8. The method of claim 7 wherein the step of providing a wine additive combination includes providing a third wine additive that is made at least partly from concentrated or unconcentrated grape juice which is different from the first grape variety and the second grape variety.

9. The method of claim 1 wherein the step of selectively adding includes the first wine additive being made from freeze dried grape juice.

10. The method of claim 1 wherein the step of selectively adding includes the first wine additive being made from concentrated grape juice.

11. A method for adjusting the flavor of a wine after the wine is opened, the wine being made at least partly from a first grape variety, the method comprising the steps of:
providing a wine additive combination that includes a first wine additive, and a second wine additive, the first wine additive being made at least partly from concentrated grapes having a first composition, the second wine additive being made at least partly from concentrated grapes having a second composition that is different from the first composition;
selecting one of the wine additives based on which wine additive is made at least partly from grapes that approximately match the first grape variety; and
selectively adding the selected wine additive to the wine.

12. The method of claim 11 further comprising the step of testing the wine to determine the amount of the selected wine additive that should be added to the first wine.

13. The method of claim 11 wherein the step of providing a wine additive combination includes at least one of the wine additives being made from freeze dried grape juice.

14. The method of claim 11 wherein the step of providing a wine additive combination includes at least one of the wine additives from concentrated grape juice.

15. A wine additive combination for adjusting the flavor of a first wine and a second wine, after the wines have been opened, the first wine being made at least partly from a first grape variety, the second wine being made at least partly from a second grape variety that is different from the first wine variety, the combination:
a first wine additive that is made at least partly from concentrated grape juice that approximately match the first grape variety; and
a second wine additive that is made at least partly from concentrated grape juice that approximately match the second grape variety.

16. The wine additive combination of claim 15 wherein the first wine additive is made at least partly from the first grape variety, and wherein the second wine additive is made at least partly from the second grape variety.

17. The wine additive combination of claim 15 further comprising a third wine additive that is made at least partly from concentrated grape juice that approximately match a third grape variety that is different from the first grape variety and the second grape variety.

18. The wine additive combination of claim 15 wherein at least one of the additives is made from freeze dried grape juice.

19. The wine additive combination of claim 15 wherein at least one of the additives is made from concentrated grape juice.
